(19) United States
(12) Patent Application Publication
(10) Pub. No.: US 2006/0054105 A1
(43) Pub. Date: Mar. 16, 2006

(54) Disassemblable pet toy

(76) Inventors: Jack W. Renforth, Aurora, CO (US); Carol J. Woodruff, Denver, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 10/940,578

(22) Filed: Sep. 13, 2004

(51) Int. Cl. A01K 29/00

(52) U.S. Cl. 119/708

(57) ABSTRACT

A pet toy includes a mount, a support, and a first object. In one embodiment, a first end of the support is pivotally connected to the mount so that a second end of the support is permitted pivot about the mount. The second end of the support is connected to a first end of a mast, and the first object is supported by a second end of the mast. A second object may be operatively connected to the first object, and may contain an aromatic substance attractive to domesticated pets, may produce a noise when struck, or both.

### BACKGROUND OF THE INVENTION

1. Field of the Invention

The present invention is directed to the field of pet supplies and, more particularly, to implements for entertaining pets.

2. Discussion of Related Art

Many people enjoy watching their pets play, and therefore create toys or other implements to encourage them to do so. Also, when pets are left alone, i.e., without human company, they can become bored and/or agitated. Therefore, when left alone for long periods of time, pets can become mischievous and damage property in the area in which they are confined. For example, if a cat is left alone in a person's home, the cat may urinate or defecate in an improper place, or may claw or scratch furniture, drapes, etc., out of boredom and/or spite for being left alone. In addition, even if a particular pet does not engage in such deviant behavior, often the pet's owner will feel guilty each time he or she leaves the pet alone. For these reasons, many pet owners find it desirable to provide toys or other implements to keep their pets entertained and/or distracted for as long as possible when left alone.

It is known that cats can be kept amused by objects that swing through the air. This may be true, for example, because such objects resemble flying creatures (e.g., birds, bats, insects, etc.), and the cats think or pretend that they are playing with or attacking such creatures. For this purpose, several prior art “cat toy” devices employ elongated, elastic beams having objects (which are intended to entice cats) dangled from their distal ends by pieces of string or chain. Some of these devices use beams having proximal ends that are adapted to be hand-held by cat owners so that the owners can dangle and selectively move the objects in front of their cats to keep them entertained. Other such prior art devices are adapted to be secured to the tops of doors or doorways using snap-on clips. Necessarily, the devices mounted on the tops of doors employ relatively long (e.g., six foot) strings to dangle the objects so that they can be reached by cats on the ground. It is known to use elastic strings for the devices mounted to the tops of doorways so as to increase the dynamic action of the dangled object.

While these door-mounted cat toys can be manipulated by cats without requiring any intervention by the cats' owners, thereby permitting the devices to keep cats entertained while their owners are away, Applicants have recognized that it is not always desirable to mount these types of pet toys only on doors. Generally, doors are located only where entry to or exit from a residence, room, closet, or the like, is required. Pet owners may find it annoying to have to negotiate around dangling strings and objects each time they use doors to which such devices are attached. Additionally, pet owners may simply want to install such devices at places other than where doors are located. For example, an owner may enjoy watching his or her pet play with such a toy, and a door may not be located at a place that is convenient or comfortable for the owner to do so.

Additionally, Applicants have recognized that, although these types of door-mounted cat toys can be quite effective in keeping cats entertained for short periods of time, a cat may tend to lose interest in such a toy after an extended period of use because the dangling object always returns to the same position when it stops moving. That is, with such a door-mounted cat toy, when a cat swats the dangling object with a paw or otherwise causes the object to move through the air, the elasticity of the beam permits the beam to flex, and the beam oscillates back and forth before finally coming to rest in its initial position. This oscillating of the beam can cause the object to move about rapidly, thereby enticing the cat to hit it again. However, because the beams of such devices always return to the same position after having been caused to flex, the objects dangled therefrom also always return to the same position in front of the door. Applicants have recognized that, for this reason, cats eventually tend to lose interest in playing with the dangling objects. Applicants hypothesize that this is true because the dangled objects of such devices do not mimic the behavior of real creatures insofar as real creatures would not tend to return to the same location each time they stop moving. Rather, a real creature is more likely to come to rest at a different location each time it stops moving.

What is needed, therefore, is an improved pet toy.

### SUMMARY OF THE INVENTION

According to one aspect of the present invention, a pet toy includes a mount, a support, a mast, and a first object. The support has proximal and distal ends, with the proximal end being pivotally connected to the mount so that the distal end is permitted pivot about the mount. The distal end of the support couples to a proximal end of the mast, while the distal end of the mast supports the first object. The coupling between support and mast may be a removable coupling, such that the mast may be removed from the support. The coupling may take the form of a threaded connection and/or a collar.

A second object may be operatively connected to the first object, and may produce a noise when the first object is struck.

According to another aspect of the present invention a pet toy includes a mount, an elongated, elastic support, and one or more objects. The mount is adapted to contact as few as two external surfaces of a structure to which the mount is to be attached. The support, which is straight when it is not flexed, has first and second ends, with the first end being supported by the mount, and with the object(s) being supported by the second end.

### BRIEF DESCRIPTION OF THE DRAWINGS

FIG. 1 shows an illustrative embodiment of a pet toy configured in accordance with the present invention;

FIG. 2 is a side view of the pet toy of FIG. 1 in which the bouncing action of the toy's support is illustrated;

FIG. 3 is a perspective view of the cat toy of FIGS. 1-2 in which the pivoting action of the toy's support is illustrated;

FIG. 4 is a perspective, exploded view of the pet toy of FIGS. 1-3;

FIG. 5 shows the support of the pet toy of FIGS. 1-4 and an object attached to a distal end thereof according to one embodiment of the invention;

FIGS. 6A-D shows several views of the mount of the pet toy of FIGS. 1-5;

FIG. 7 depicts a second embodiment of a pet toy configured to be at least partially disassembled; and

FIG. 8 depicts the pet toy of FIG. 7, packaged.

### DETAILED DESCRIPTION OF THE INVENTION

As mentioned above, prior art pet toys that employ elastic beams adapted to be mounted to the tops or bottoms of doors suffer from the disadvantage that pet owners can install such devices only where doors are located. According to one aspect of the present invention, this disadvantage is overcome by employing a mount (which supports a support having an object dangled therefrom) that is adapted to be mounted to any external surface of a structure, e.g., a wall, window, table top, table leg, or the like, and is not required to be, but may be, mounted to a door.

Additionally, as also mentioned above, such prior art door-mounted pet toys suffer from the disadvantage that the distal ends of their elastic supports, and the objects dangled therefrom, always return to the same location after the supports cease bouncing. According to another aspect of the present invention, this disadvantage is overcome by pivotally connecting a proximal end of a support (which has an object dangled from its distal end) to a mount so that the distal end of the support is permitted to pivot about the mount. With embodiments of the invention incorporating this aspect, each time a pet causes the dangling object to move, e.g., by swatting at it with a paw, the support can pivot so that the distal end of the support can come to rest at any location within the support's allowed pivoting range. Therefore, with such embodiments, the dangling object also can come to rest at a different location after each time it is swatted by the pet, and the pet is more likely to remain interested in the object because the object behaves more like that of an actual creature.

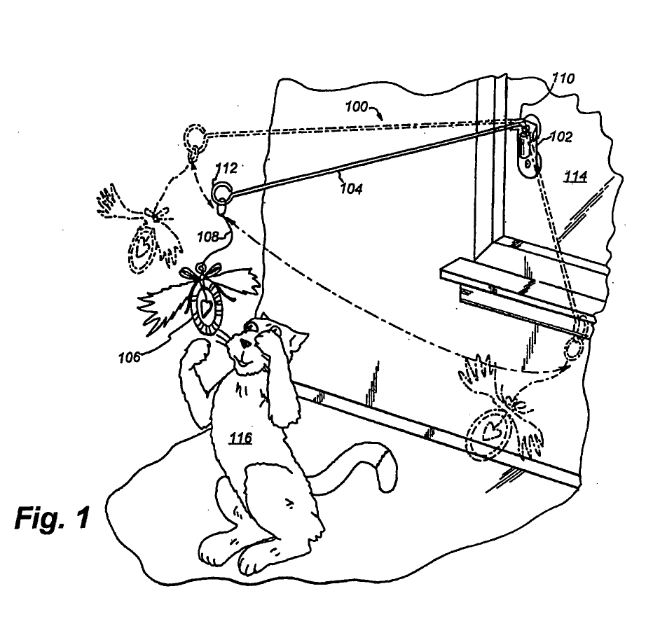

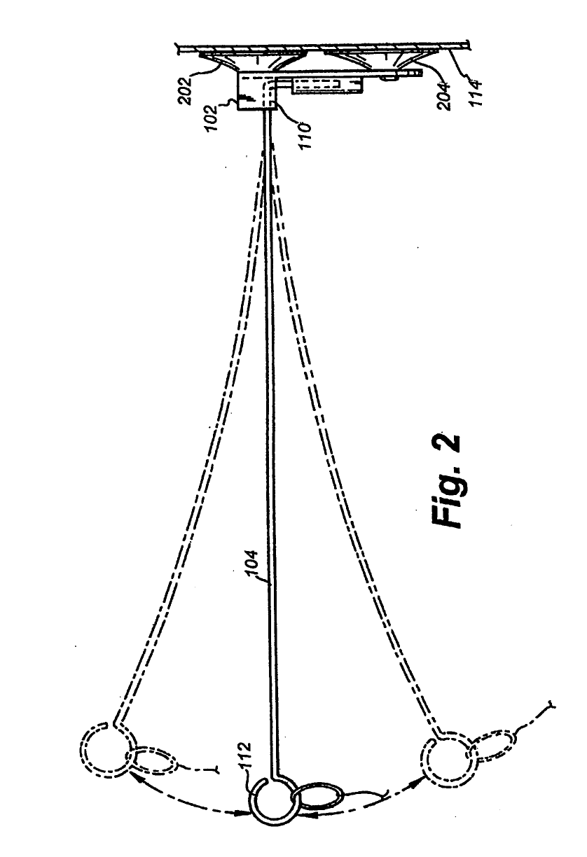

FIGS. 1-6 show an illustrative embodiment of a pet toy 100 which incorporates the above-described aspects of the present invention. In the illustrative embodiment shown, a proximal end 110 of an elongated support 104 is pivotally connected to a mount 102, and an object 106 is dangled (by a tether 108) from a distal end 112 of the support 104. In the embodiment shown, both the support 104 and the tether 108 are elastic (i.e., both flexible and resilient). Therefore, when a cat 116 swats at the object 106, the support 104 can flex and then return to its original shape (see FIG. 2), and the tether 108 can stretch and then return to its original length. In this manner, the object 106 can bounce randomly as a result of the combined forces generated by these two elastic elements. It should be appreciated, however, that the invention is not limited in this respect, and that a non-elastic support and/or a non-elastic tether or chain may alternatively be employed.

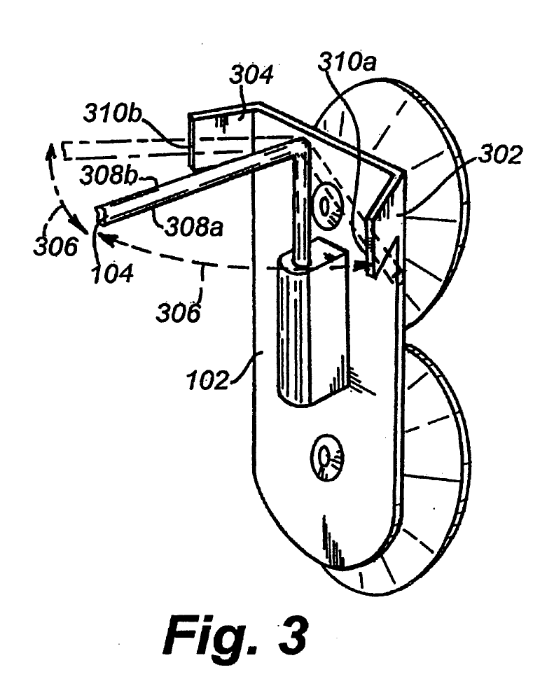

FIGS. 1-3 illustrate the various ranges of motion of the support 104 in accordance with one embodiment of the invention. As shown in FIGS. 1-3, when the cat 116 (FIG. 1) or other animal swats or otherwise causes the object 106 to move, the support 104 can be caused to flex (see FIG. 2) and/or can be caused to pivot with respect to the mount 102 (see FIG. 3).

When the support 104 is caused to flex (FIG. 2) in response to force being exerted on the object 106, its distal end 112 is caused to bounce with respect to the mount 102. To achieve this bouncing action of the distal end 112, the support 104 may be configured in any of numerous ways and may be made of any of numerous materials, and the invention is not limited to any particular configuration or material. In the illustrative embodiment of FIGS. 1-3, for example, the entire support 104 is made of steel wire so that it will flex and return to its original shape in response to the amount of force that would typically be exerted by a domestic animal such as a cat. Alternatively, the support 104 may, for example, be made of stainless steel wire or spring wire. In some embodiments, only one or more portions of the support 104 (e.g., only the proximal end 110) may be made of an elastic material, with the remainder of the support 104 being non-elastic, to achieve a similar result. In another alternative embodiment, a spring-loaded hinge (not shown) or simply a spring (not shown) may be located at the proximal end 110 to so that the distal end 112 can bounce as shown in FIG. 2. FIG. 2 illustrates (in phantom) how the support 104 may be flexed in accordance with one embodiment of the invention, with the resting position of the support 104 being shown using solid lines in FIG. 2. It should be appreciated, however, that the support 104 may flex more or less than shown (in phantom) in FIG. 2, and that the invention is not limited a support that flexes to any particular minimum or maximum position. Again, while embodiments in which the distal end 112 bounces (e.g., as shown it FIG. 2) can provide significant advantages, it should be appreciated that the invention is not limited in this respect, and all embodiments of the invention need not incorporate this feature.

FIG. 3 illustrates how the support 104 can pivot with respect to the mount 102 in accordance with one embodiment of the invention. In the embodiment shown, the mount 102 includes a pair of arms 302 and 304 that are positioned so as to limit the pivoting range of the support 104. In FIG. 3, the outermost limits of the pivoting range of the support 104 are shown in phantom, and the pivoting motion of the support 104 is illustrated by arrows 306. As shown, the pivoting of the support 104 is limited when sides 308a and 308b of the support 104 contact ends 310a and 310b of the arms 302 and 304, respectively.

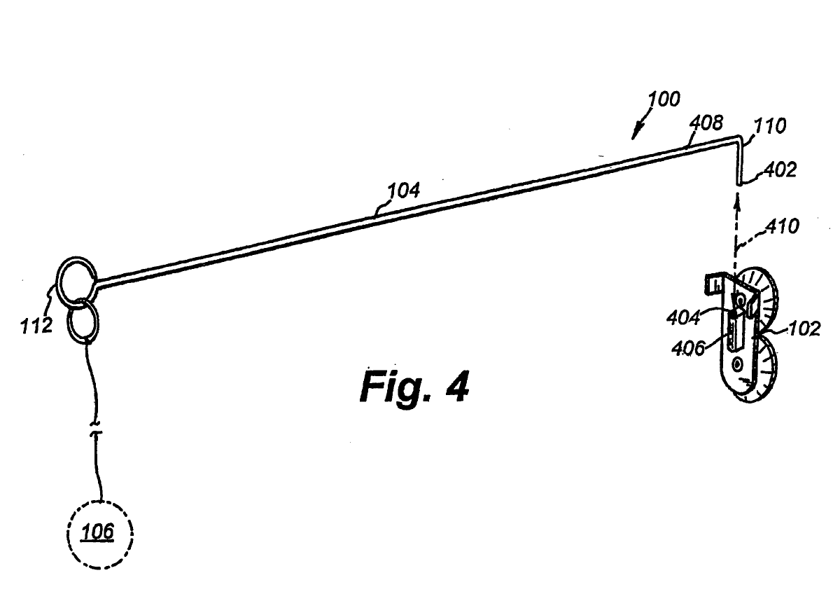

The support 104 may be pivotally connected to the mount 102 in a number of alternative ways, and that the invention is not limited to any particular type of connection. FIG. 4 illustrates one illustrative example of how this pivotal connection may be established. In the embodiment shown, the proximal end 110 of the support 104 includes an end 402 that is bent at a right angle with respect to an elongated section 408 of the support 104. As illustrated by the arrow 410, the end 402 may be inserted into a corresponding hole 404 formed within a projecting portion 406 of the mount 102. In this manner, so long as the diameter of the hole 404 is at least slightly larger than the diameter of the end 402, the end 402 will be permitted to pivot within the hole 404. Again, it should be appreciated that the manner of making the pivotal connection between the proximal end 110 and the mount 102 is not critical, and that any other technique may alternatively be used to establish such a connection.

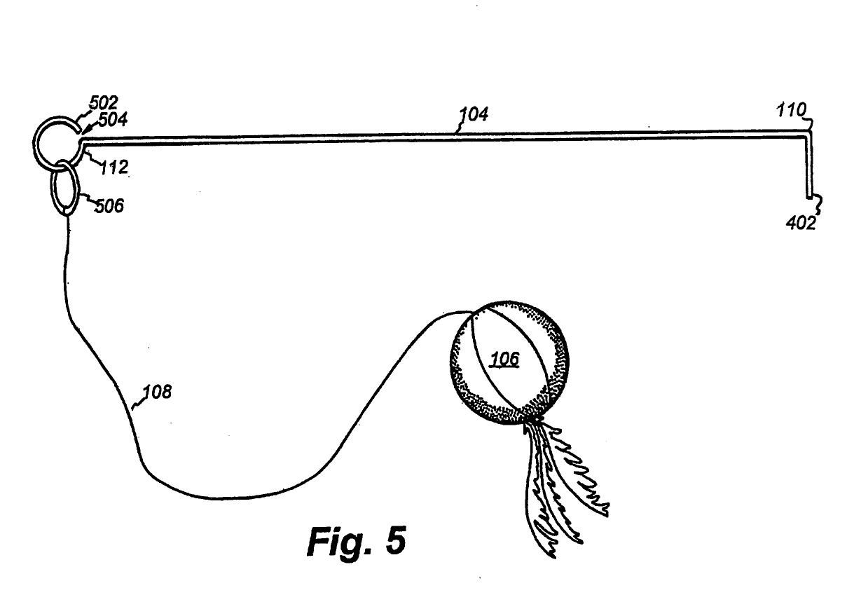

The object 106 which is supported by the distal end 112 of the support 104 may take on any numerous forms, and the invention is not limited to any particular type of object. Ideally, the object 106 is selected so as to be enticing to the animal that will be using the toy. In embodiment for use with cats, for example, objects 106 that look like birds or objects 106 that contain catnip may be serve this purpose well. Examples of two objects that may be used are illustrated in FIGS. 1 and 5. While a single object is dangled from the distal end 112 of the support 104 in each of these examples, it should be appreciated that the invention is not limited in this respect, and that two or more objects may be used in alternative embodiments.

In whatever form it takes, the object 106 may be supported by the distal end 112 of the support 104 in any of the number of ways, and the invention is not limited to any particular securing technique. In the illustrative embodiment shown, the object 106 is supported by the distal end 112 using a tether 108 connected to a ring 506. As shown, the distal end 112 of the support 104 may also includes a ring portion 502. The ring 502 may either be integral with the support 104 (as shown in FIG. 5), or may be a separate component attached to the distal end 112 of the support 104. In the example shown, the ring 506 may be inserted into a gap 504 in the ring 502 so that the rings 502 and 506 can be interlocked with one another. In this manner, any of several different objects 106, each having a respective tether 108 and ring 506 attached thereto, may be selected and attached to the distal end 112 of the support 104 via the gap 504. It should be appreciated that the invention is not limited in this respect, however, and that other devices and/or techniques may be used to removably secure the object 106 to the distal end 112 of the support 104. In some embodiments, for example, the ring 506 may have a gap formed therein which permits the rings 502 and 506 to be interlocked. In other embodiments, the object 106 and/or the tether 108 may be permanently secured to the distal end 112. In this regard it should also be understood that some embodiments may simply not employ the tether 108. Instead, the object 106 may, for example, be attached directly to the distal end 112 of the support 104.

When used, the tether 108 may be made of any of numerous materials, and the invention is not limited to any particular type of tether. As discussed above, in one embodiment of the invention, the tether 108 is elastic so as to provide a further degree of action for the object 106 when force is applied thereto. Alternatively, the tether 108 may be a non-elastic string or a linked or beaded chain that merely permits the object 106 to dangle from the distal end 112 of the support 104.

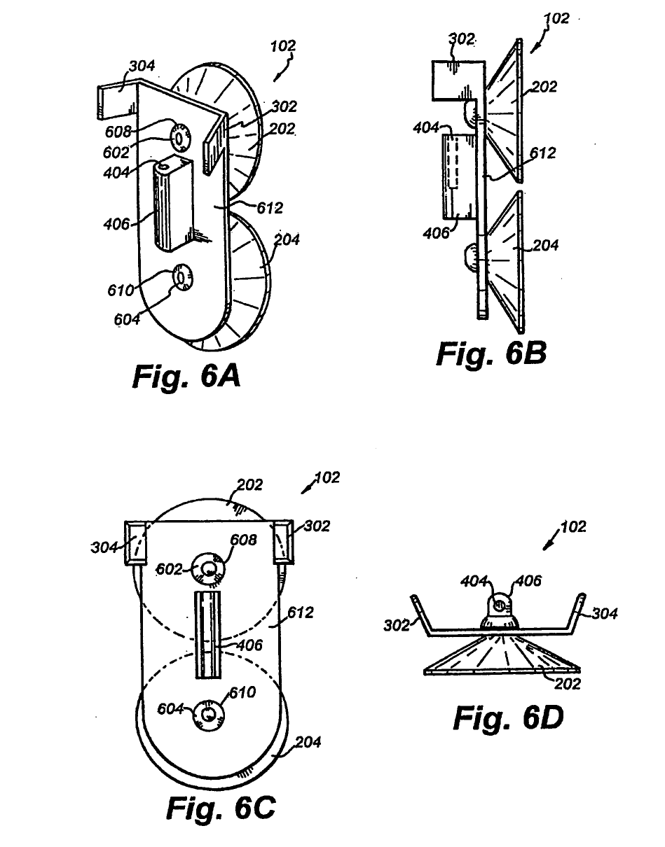

The mount 102 may be configured in any of numerous ways, and the invention is not limited to any particular type of mount. In the illustrative embodiment shown in the figures, for example, the mount 102 includes a pair of suction cups 202 and 204 which permit it to be attached to a vertically-oriented, smooth, clean surface. FIGS. 6A, 6B, 6C, and 6D show, respectively, perspective, side, front and top views of the mount 102 according to this example embodiment. In one embodiment, the entire mount 102 (except for the suctions cups 202 and 204) is made of acrylonitrile butadiene styrene (ABS). The suction cups may, for example, be made of polyvinyl chloride (PVC). Alternatively, the mount may, for example, be made of high impact polystyrene, and the suction cups may, for example, be made of medium density vinyl. In the embodiment shown in the figures, annular portions 602 and 604 of the suction cups 202 and 204 may be compressed and inserted into corresponding holes 608 and 610 in a planar portion 612 of the mount 102. After being so inserted, the annular portions 602 and 604 can expand radially so that the suction cups 202 and 204 are secured within the holes 608 and 610.

In alternative embodiments, the mount 102 may instead employ fasteners, e.g., screws, nails, rivets, bolts, hook and loop fasteners, or the like, to fasten the mount 102 to any surface. In some embodiments, the mount 102 may be configured such that it may be mounted to a horizontally-oriented surface such as a table top, or to a surface at a particular angle with respect to the ground. In yet other embodiments, the mount may be specially adapted to be mounted to a rounded surface such as a pole or the leg of a table or chair. For example, the mount 102 may have a rounded shape that can conform to such a rounded surface, and/or the mount 102 may include clamps (not shown) or the like which can secure the device about such a rounded structure.

As used herein, the term “external surface” refers any exposed surface of a structure (i.e., any outermost surface of a structure that is not resting on the floor or another structure) that has boundaries defined by sudden angular changes in the structure's contours. For example, according to this definition, a door has six external surfaces (i.e., a front and back, a top and bottom, and two sides), a round table leg has only one external surface (i.e., the outer surface of the cylindrical leg), a window pane has two external surfaces (i.e., a front and back), and each of the four walls in a room constitutes a separate, single external surface. The term “external surface” of a structure does not, as used herein, include the inner portions of a structure that may be contacted by fasteners which penetrate the structure's outermost surface to secure an object, e.g., the mount 102, to the structure. Therefore, in embodiments of the invention that employ such fasteners to secure the mount 102 to a structure, the inner portions of the structure contacted by the fasteners are not “external surfaces” of the structure, as that term is used herein.

In the embodiment shown in the figures, it should be noted that the mount 102 needs only to contact a single external surface of any structure, e.g., a door, wall, window, cabinet, table leg, or the like, and does not need to contact any additional external surfaces of such a structure, in order to be secured thereon. In alternative embodiments, the mount 102 can be configured to contact only two external surfaces of a structure. For example, the mount may be configured to be mounted to both the top and the side of a table top or desk, or may be configured to be mounted at the junction of two walls (i.e., a corner of a room) or the junction of a wall or the ceiling of a room. These embodiments can be contrasted to the prior art door mounted cat toys described above, which employ mounts that are required to contact three separate external surfaces (i.e., the front and back, as well as the top or bottom) of a door to secure the toys thereto. This feature of the present invention provides a significant advantage over such prior art devices in that a pet owner is permitted to secure the pet toy to virtually any location inside or outside a residence, and is not limited to locations where a door is located.

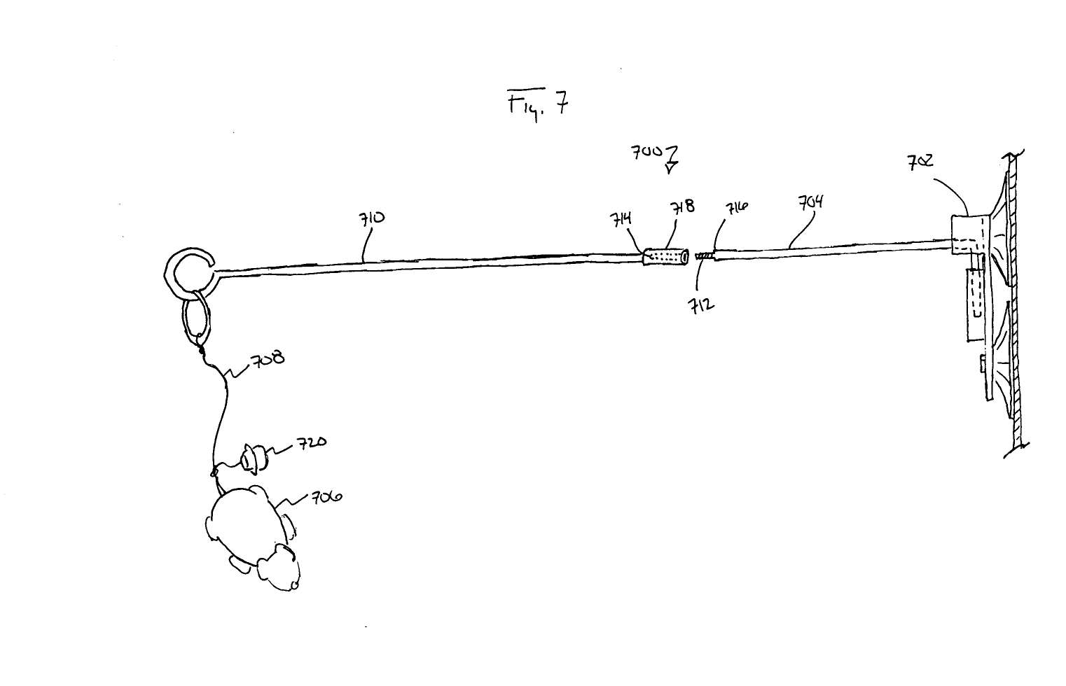

FIG. 7 depicts an alternate embodiment 700 of the present invention. This embodiment includes a mount 702, support 704, and object 706 attached to a tether 708. As with prior embodiments described herein, the object 706 is sized, shaped, and/or colored to attract the attention of a domestic pet, such as a cat or dog.

Unlike the embodiment described with respect to FIGS. 1-6, however, the present invention attaches the end of the tether 708 opposing the object 706 to a mast 710, rather than directly to the support 704. The proximal end of the mast 710 affixes to the distal end of the support 704, and the tether 708 attaches to the mast's distal end. In the present embodiment, the support includes a threaded male segment 712 at its distal end, and a mating, threaded female recess 714 is defined in the proximal end of the mast. The female recess is formed in a collar 718.

The support 704 may be threaded into the mast 710 to attach the two elements. A shoulder 716 extends radially outwardly from the male segment 712 of the support. The diameter of the support between the shoulder 716 and proximal end is approximately the same as the diameter of the mast 710 (excluding the collar 718). The collar 718 generally reinforces the coupling by providing thicker sidewalls for the recess 714 than would be present if the recess were formed directly in the mast 710. The thicker collar sidewalls permit greater stress to be applied transverse to the longitudinal axes of the mast and support without breaking or otherwise severing the connection therebetween.

The collar 718, mast 710, and support 704 are generally made of metal to minimize bending or breaking resulting from forces applied to the toy 700 by a pet. Alternate embodiments may manufacture the collar 718, mast 710, and/or support 704 from a variety of materials, such as plastic, wood, composite materials, and so forth.

In some embodiments, the collar 718 may be omitted so that the mast 710 and support 704 together present a relatively continuous, and possibly seamless, appearance when joined.

Although the present embodiment employs a threaded connection with the male segment 712 formed on the support 704 and the female recess 714 formed in the mast 710, alternate embodiments may employ different connection structures. For example, some embodiments may employ a post-and-channel or detent structure to couple the mast and support. Yet other embodiments may employ a snap-fitting, a ball- and socket type connection, or form an annular ramp or protrusion on one of either the male or female segments with a corresponding annular groove or channel formed in the opposing segment. In short, any structure permitting the mast 710 and support 704 to be removably coupled to one another may be employed. Alternate embodiments may, for example, include the male segment 712 on the mast 710 and the collar 718 and/or female recess 714 on the support 704.

Further, alternative embodiments may use a connection structure designed to maintain a connection once the mast 710 and support 704 are fitted to one another. For example a locking collar or other mechanism may maintain a fixed relationship between ramp and support, resisting decoupling. Alternately, the annular ramp and channel discussed above may be used, with a flat annular ring parallel to the lateral axis of the mast and/or support formed at the edge of the ramp furthest from the joinder between mast and support. The channel sidewall may be formed with a surface paralleling and abutting (or nearly abutting) the flat annular ring when mast and support are interconnected. The ramp may thus be relatively easily inserted into the corresponding cavity to permit mating, but the combination of flat annular ring and parallel channel surface would resist decoupling.

Any of the coupling mechanisms between support 704 and mast 710 described herein may be implemented in any of the embodiments described herein. Additionally, regardless of the coupling structure used, and specifically with respect to the threaded connection and collar 718 described herein, the coupling structure is formed to permit the flexing described above and illustrated in FIG. 2.

In the present embodiment, the length of the support 704 is generally shorter than in prior embodiments to account for the added length of the mast 710. Further, although the present embodiment depicts the length of the support and mast as approximately equal, either support or mast may be longer in alternate embodiment. Additionally, alternate embodiments may vary the overall length of the combined mast and support.

As with many products, the present domestic pet toy 700 may be marketed and sold to produce revenue. Typically, the pet toy 700 is packaged in some manner to attract a consumer's attention and interest while occupying shelf space in a store. In many stores, the shelf space occupied by a product is a factor determining placement of the product, number of products stocked, and possibly even the significance of any marketing promotions for a given product. Further, customers may be reluctant to purchase what they perceive as bulky objects when smaller, slimmer, or less weighty alternatives are readily available.

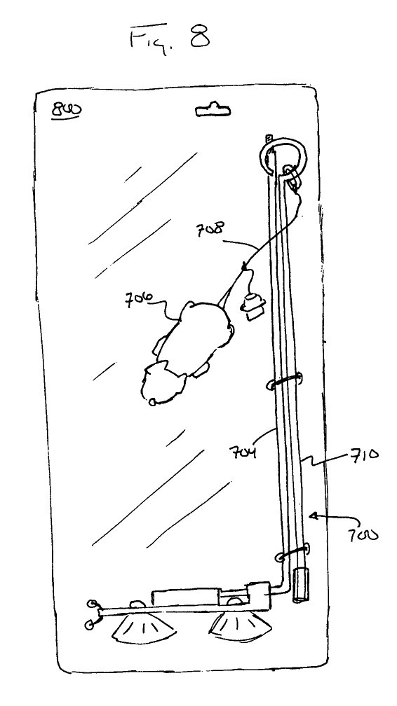

Reducing the length of the support 704 and adding a threaded connection with the mast 710 permits the toy 700 to occupy a smaller area when packaged than previously-discussed embodiments. For example, FIG. 8 depicts the present embodiment 700, including mount 702, support 704, object 706, tether 708 and mast 710, affixed to a package 800. (Although a flat panel is depicted as the package in FIG. 8, any form of packaging, such as a box, may be used.) When packaged, the mast may be disassembled from the support and placed parallel to the support, reducing the area of any toy packaging. With respect to previously-discussed embodiments, the overall length of the support requires the packaging be extended in at least one dimension to account therefor. This, in turn, may reduce the shelf space many retailers will provide for the domestic animal toy 700, cause retailers to position the animal toy in a less desirable location (such as a top shelf or end of aisle), and so forth. By incorporating the afore-described threaded connection between mast 710 and support 704 and reducing the dimensions of the support 704, additional animal toys 700 may be sold and revenues increased.

The advantages of shaping an object 706 (dangling from a tether 708) like a bird, mouse, animal, or other shape enticing to a domestic animal have already been discussed. Such shapes may provide visual stimulation for the domestic animal and encourage play with the toy 700. Additionally, the object 706 may include a bell 720 or other item producing noise when the domestic animal interacts with the toy 700, for example by swatting at or swinging the object. The aural feedback may enhance the domestic animal's pleasure in the toy 700, causing the animal to interact with the toy for a longer period of time. Typically, the bell 720 or other object is connected either directly or indirectly to the first object 706, such that the noise is produced when the first object is struck or otherwise swings. Additionally, the bell 720 may contain catnip or another aromatic substance attractive to a pet to encourage the pet to play with the toy 700.

Having thus described certain embodiments of the present invention, various alterations, modifications and improvements will readily occur to those skilled in the art. Such alterations, modifications and improvements are intended to be within the spirit and scope of the invention. Accordingly, the foregoing description is by way of example only and is not intended as limiting. The invention is limited only as defined in the following claims and the equivalents thereto.

What is claimed is:

1. A pet toy, comprising:
a mount;
a support having a proximal and a distal end, the proximal end being pivotally connected to the mount so that the distal end is permitted to pivot about the mount;
a mast having a proximal and a distal end, the proximal end of the mast coupled to the distal end of the support;
at least one object supported by the distal end of the mast; wherein
the mount is adapted to be mounted to a vertically-oriented surface; and
the mount includes at least one suction cup adapted to adhere the mount to the vertically-oriented surface.

2. The pet toy of claim 1, wherein the proximal end of the mast is removably coupled to the distal end of the support.

3. The pet toy of claim 2, further comprising:
a threaded male segment formed on a first of the proximal end of the mast and the distal end of the support; and
a threaded female recess formed on a second of the proximal end of the mast and the distal end of the support; wherein
the female recess accepts the male segment to form a removable coupling between the proximal end of the mast and distal end of the support.

4. The pet toy of claim 3, wherein the second of the proximal end of the mast and the distal end of the support further comprises a collar, the threaded female recess formed in the collar.

5. The pet toy of claim 2, further comprising a detent structure removably coupling the proximal end of the mast to the distal end of the support.

6. The pet toy of claim 2, further comprising a post-and-channel structure removably coupling the proximal end of the mast to the distal end of the support.

7. The pet toy of claim 1, further comprising a second object operably connected to the first object, the second object operative to produce a noise when the first object is struck.

8. The pet toy of claim 7, wherein the second object is a bell.

9. The pet toy of claim 7, wherein the second object is directly connected to the first object.

10. The pet toy of claim 7, further comprising an aromatic substance contained within the second object.

11. The pet toy of claim 8, wherein the aromatic substance is catnip.

12. The pet toy of claim 1, further including a tether disposed between the second end of the support and the at least one object such that the at least one object dangles from the second end via the tether.

13. The pet toy of claim 1, wherein the support is elastic.

14. The pet toy of claim 1, wherein the mast is fixedly coupled to the support.

15. The pet toy of claim 1, wherein the mast vibrates with vibration of the support.

16. A packaged pet toy, comprising:
a mount;
a support having a proximal and a distal end, the support proximal end being pivotally connected to the mount so that the distal end is permitted to pivot about the mount, the support distal end comprising a first connection structure;
a mast having a proximal and a distal end, the proximal end of the mast comprising a second connection structure operative to mate with the first connection structure;
at least one object supported by the distal end of the mast;
a package at least partially supporting the mount, support, mast, and object; wherein
the support and mast are separated upon the package.

17. The packaged pet toy of claim 16, wherein the support and mast are aligned in parallel upon the package.
